(19) United States
(12) Patent Application Publication
(10) Pub. No.: US 2006/0242565 A1
(43) Pub. Date: Oct. 26, 2006

(54) System and method for handling absolute positioning in a small screen optimized layout

(75) Inventor: Mikko K. Makela, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/109,914

(22) Filed: Apr. 20, 2005

(51) Int. Cl. G06F 17/21

(52) U.S. Cl. 715/517

(57) ABSTRACT

A system and method for handling absolute positioning of content in an optimized layout on a display of an electronic device. Content in an original layout is provided, with the content including a primary element. A background element is identified, and a model of the content is calculated, the calculation includes the determination of the position of the primary element relative to the position of the background element. The primary element is positioned in the optimized layout in the same position relative to the background element as in the original layout.

### FIELD OF THE INVENTION

The present invention relates generally to content that is displayed on electronic devices. More particularly, the present invention relates to internet content and other material that may be displayed both on large-screen and small-screen electronic devices.

### BACKGROUND OF THE INVENTION

Over the past decade, the Internet has become virtually ubiquitous in people's everyday lives. People access the Internet and associated web pages for virtual purposes, ranging from conducting business transactions, to accessing news and information, to obtaining driving directions to a particular destination.

The most common mechanism used to access the Internet is currently the personal computer. However, many other devices, such as mobile telephones and personal digital assistants (PDAs), also can access the Internet in at least a limited manner. As technology has progressed, these devices have been able to perform more and more Internet-related functions that previously could only be fully performed by personal computers. Today, the ability to view web pages and pages designed for large PC displays is coming to mobile telephones. Currently, many mobile telephones, such as the Series 60 family of mobile telephones offered by Nokia Corporation, permits the viewing of almost any web page using a native web browser.

Although the viewing of web pages on mobile telephones is a significant advancement in technology, it currently suffers from a number of serious drawbacks. Because web pages have traditionally been designed for display on personal computers, they are typically quite large in size and often include a great level of detail. However, these large web pages have serious usability issues with smaller displays such as mobile telephones, where the entire page is likely not viewable all at once and/or small details cannot be viewed at all.

Because large web pages as such are not very usable on small displays, the browsers used for accessing web pages and displaying them on small screen devices typically offer the ability to view a particular web page in a small screen optimized format. In a small screen optimized format, the web page is, for example, rendered so that it fits to the width of the small display. An example of another small screen optimized format involves keeping the web page in its original format (which can be wider than the display), but wrapping all of the text lines into the display width. This processes effectively causes the page to remain in its original width, but also makes the page significantly taller.

Small screen optimized formats generally change the page layout significantly. One of the problems caused by this change is that items defined to be shown in an absolute position are subsequently not positioned correctly after the format change. For example, if a page contains a map, an arrow is often shown on the map, pointing to the current location or a desired destination. This arrow is frequently implemented so that a small image containing only the arrow is shown on top of the page, with the arrow being positioned so that the distance to a document origin (or, for example, to an origin of the map picture) is X pixels in the horizontal direction and Y pixels in the vertical direction. If the page structure is altered in typical manner for mobile browsers or content optimization servers optimizing a page for a small screen, positioning according to such absolute coordinates does not place the arrow in the intended position. Instead, it is even possible that the arrow would be placed outside of the document, as the width of the document might be limited to the display width.

It would therefore be desirable to develop a system that overcomes the above-identified issues while still providing a user with the optimal use of a typical web page on a small screen device.

### SUMMARY OF THE INVENTION

The present invention provides for a system and method for accurately handling absolute positioning in a small screen optimized content layout. By placing an item with absolute positioning correctly in an altered layout, a model of a page, or a required part of a page, the original layout can be calculated. From this model, it can be determined how an item would be positioned in relation to the other elements on the page. Information about the relative position can be used, for example, such that for elements defined to be shown in absolute position, it is monitored which element would be immediately behind the elements. Absolutely positioned elements are then rendered on top of those elements in the optimized layout as well. Relative positions of these elements to each other can therefore be maintained. The size of the absolute positioned element can also be scaled according to the element behind it.

The system and method of the present invention provides a number of advantages over the prior art. For example, use of the present invention in a browser provides the user with the ability to view content on a small screen in a small screen optimized format, wherein the content fits to the width of phone display. At the same time, the present invention enables the same content to be rendered while substantially eliminating the translation and positioning issues identified above.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a representation of a sample image that can be translated into a small screen optimized layout in accordance with the principles of the present invention; and

FIG. 5 is a flow chart showing a process by the present invention may be implemented.

### DETAILED DESCRIPTION OF THE PREFERRED EMBODIMENTS

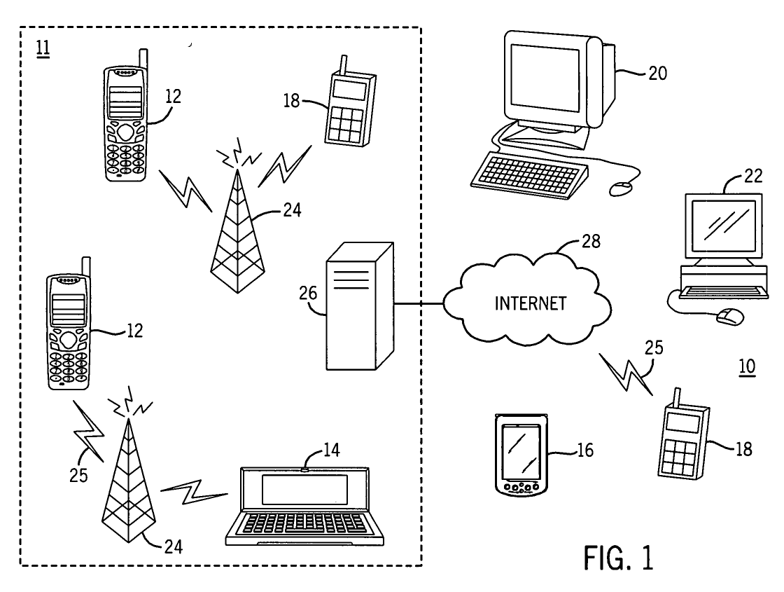

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

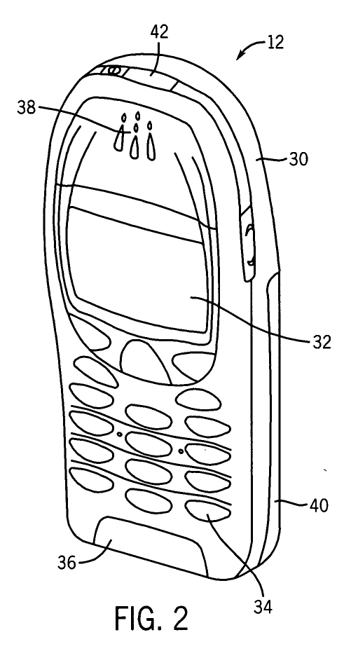

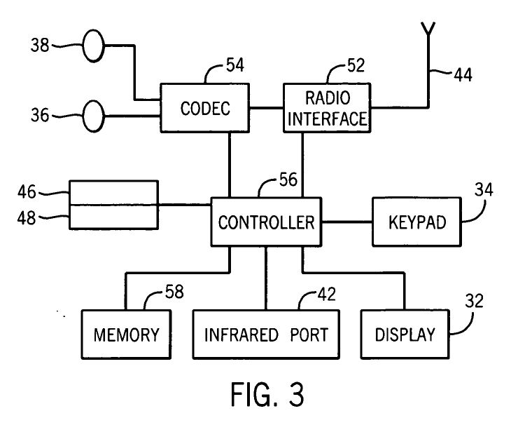

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention provides for a system and method of correctly placing an item with absolute positioning in an altered layout when a large piece of content, such as a web page, is converted to a small screen optimized format. By placing an item with an absolute position correctly in an altered layout, a model of the page (or the required portion of the page) in the original layout can be calculated or estimated. From this model, it can be determined how an item should be positioned in relation to the other elements on the page.

“Absolute positioning” can be defined in a number of manners, each of which is applicable to the present invention. For example, this can refer to positioning defined in terms of any absolute unit, such as pixel, inch, etc. It can also refer to combinations of absolute units, such as in a situation where a vertical position is defined in pixels and a horizontal position is defined by inches. Absolute positioning can also refer to positioning defined in any manner that can be interpreted in absolute units. For example, if it is determined that a horizontal distance for an item from a document origin is thirty percent of the document's width, and it can be determined that the document's width is one thousand pixels, then the position in absolute units can be derived to be three hundred pixels. In this instance, the width can either be directly defined by an attribute, or the width can be indirectly determined, for example, by rendering the document in its original format and calculating or estimating the original width of the document.

Information about the relative position of a primary element can be used, for example, so that for primary elements that are defined for exhibition in an absolute position, the system determines which background element should be immediately behind them. Subsequently, absolutely positioned primary elements, such as arrows indicating a location on a background map, are rendered on top of the same background elements in the optimised layout. Relative positions of these elements to each other can therefore be maintained. Additionally, in one embodiment of the present invention, the size of the absolutely positioned primary element can also be scaled according to the background element behind it.

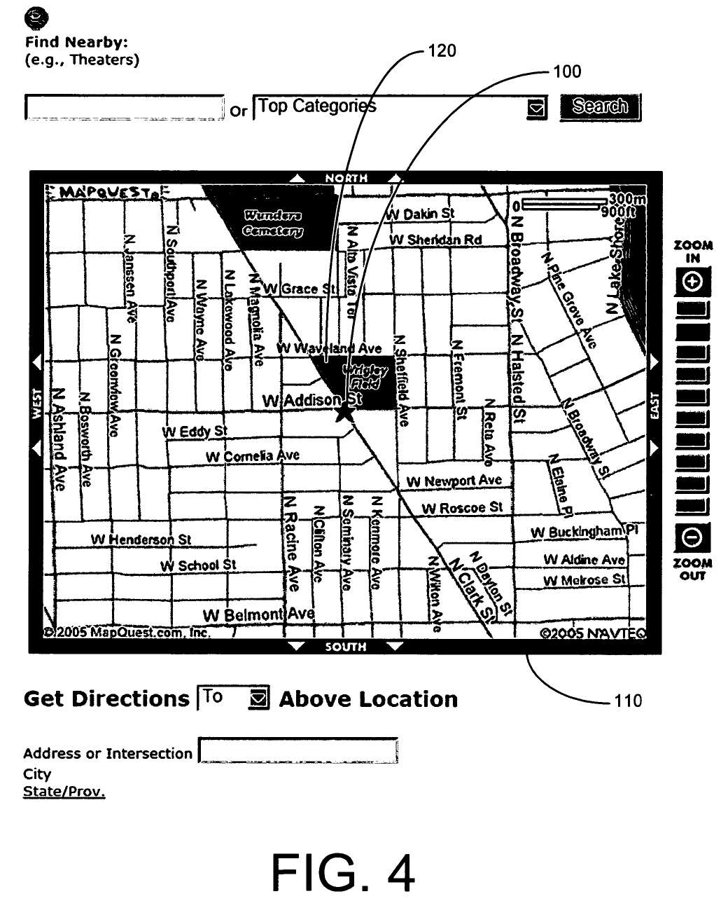

FIG. 4 shows a layout of a portion of a sample internet web page showing a primary element 100 in the form of a star superimposed over a background item 110 in the form of a map. It should be noted that the present invention is not limited to any particular type of object or web page, and it is also possible to use the present invention in conjunction with virtually any type of non-Internet content as well. The background item 110 can also take the form of a wide variety of items, such as a Macromedia flash object. A background element 120 is defined within the background item 110, with the background element 120 being directly underneath the primary element. The background element 120 and the background item 110 can also be identical.

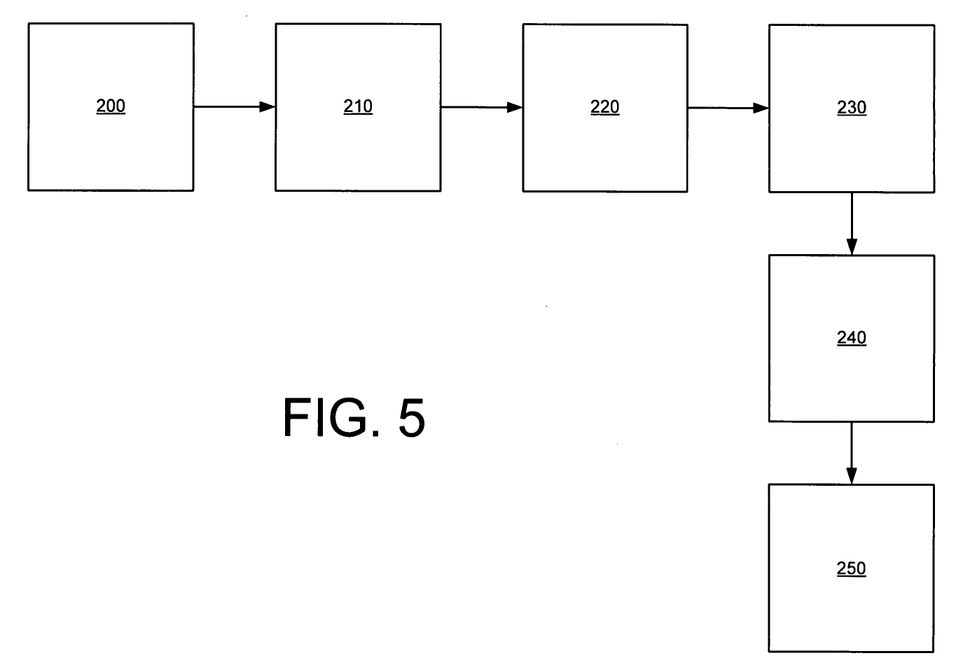

The following is an example of the implementation of one embodiment of the present invention, as represented in FIG. 5. At step 200, an original piece of content is provided with the primary element 100 superimposed over the background item 110 at the background element 120. At step 210, a calculated model of the content is created. As an example, the calculated model can show that the primary element 100 would, in the original layout, be located directly above the background element 120. The distance of the center point of the primary element 100 from the origin of the background element 120 would be, for example, thirty percent of the height of the background item 110, and forty percent of the width of the background item 110. At step 220, the background item 110 is scaled for the optimized layout. For example, the background item 110 can be scaled to fifty percent of its original size. At step 230, the primary element 100 is rendered on top of the background item 110 in the optimized layout, so that distance between the center point of the primary element 110 and the origin of the background element 120 is the same as was measured in the original layout, for example, thirty percent of the height and forty percent of the width of the background item 110 according to its size in the optimised layout. The size of the primary element 100 is then scaled at step 240 to correspond to the scaling of the background item 110, for example fifty percent of its original size.

In the event that a user wants to open the background item 110 (or both the background item 110 and the primary image 100) into an image viewer, the user can be provided with an option to view both the background element 120 and the primary element 100 in combined form such that the two items are viewed in the same way as they are shown on a page in either an optimized layout or an original layout. This is represented at step 250. This feature is particularly useful with maps, where the user could zoom or save the map with a location pointer. In the case where an original layout is used, this feature is useful to the useful even though the layout is not optimized.

It should also be noted that the background item 110 can also serve as the background element 120. For example, if the background item is a normal image, it can serve as the background element 120 in several situations. For example, when determining a correct location for the primary element 100, the origin of the background item 110 can be used as a basis so that the primary element 100 is placed at a point whose distance from the origin of the background item 110 is thirty percent of the height and forty percent of the width of the background item 110.

Additionally, it should also be noted that the present invention can be used in either two-dimensional or three-dimensional situations. This can be accomplished by using x, y and z axes when positioning the primary element 100 relative to the background element 120.

The system and method of the present invention can be implemented in a client and/or in a content optimization server within a network such as those depicted in FIG. 1. The present invention provides for a significant improvement to current systems in which relatively positioned elements ultimately appear in an incorrect location in an optimized layout. In particular, with the present invention, a wide variety of internet mapping programs and services become much more usable on mobile device than is the case with conventional systems.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for handling absolute positioning of content in an optimized layout on a display of an electronic device, comprising:
providing content in an original layout, the content including a primary element;
identifying a background element within the content;
calculating a model of the content, the calculation including determining the position of the primary element relative to the position of the background element;
scaling the background element for use in the optimized layout; and
positioning the primary element in the optimized layout in the same position relative to the background element as in the original layout.

2. The method of claim 1, wherein the background element comprises at least a portion of a background item, and wherein the primary element overlaps with at least a portion of the background item in the original layout.

3. The method of claim 2, further comprising scaling the primary element to the same degree as the background item.

4. The method of claim 2, wherein the positioning of the primary element relative to the position of the background element includes:
identifying the distance between a center point of the primary element and an origin of the background element;
measuring a length of the background item;
measuring a width of the background item;
calculating a first ratio of the identified distance to the length of the background item; and
calculating a second ratio of the identified distance to the height of the background item.

5. The method of claim 1, wherein the content comprises an Internet web page.

6. The method of claim 2, wherein the background item includes a map, and wherein the primary image comprises an indicator for indicating a location on the map.

7. The method of claim 1, wherein the electronic device comprises a mobile telephone.

8. A computer program product for handling absolute positioning of content in an optimized layout on a display of an electronic device, comprising:
computer code for providing content in an original layout, the content including a primary element;
computer code for identifying a background element within the content;
computer code for calculating a model of the content, the calculation including determining the position of the primary element relative to the position of the background element;
computer code for scaling the background element for use in the optimized layout; and
computer code for positioning the primary element in the optimized layout in the same position relative to the background element as in the original layout.

9. The computer program product of claim 8, wherein the background element comprises at least a portion of a background item, and wherein the primary element overlaps with at least a portion of the background item in the original layout.

10. The computer program product of claim 9, further comprising computer code for scaling the primary element to the same degree as the background item.

11. The computer program product of claim 9, wherein the computer code positioning of the primary element relative to the position of the background element includes:
computer code for identifying the distance between a center point of the primary element and an origin of the background element;
computer code for measuring a length of the background item;
computer code for measuring a width of the background item;
computer code for calculating a first ratio of the identified distance to the length of the background item; and
computer code for calculating a second ratio of the identified distance to the height of the background item.

12. The computer program product of claim 8, wherein the content comprises an Internet web page.

13. The computer program product of claim 9, wherein the background item includes a map, and wherein the primary image comprises an indicator for indicating a location on the map.

14. An electronic device, comprising:
a processor for processing information; and
a memory unit operatively connected to the processor, the memory unit including a computer program product for handling absolute positioning of content in an optimized layout on a display of the electronic device, comprising:
computer code for providing content in an original layout, the content including a primary element;
computer code for identifying a background element within the content;
computer code for calculating a model of the content, the calculation including determining the position of the primary element relative to the position of the background element;
computer code for scaling the background element for use in the optimized layout; and
computer code for positioning the primary element in the optimized layout in the same position relative to the background element as in the original layout.

15. The electronic device of claim 14, wherein the background element comprises at least a portion of a background item, and wherein the primary element overlaps with at least a portion of the background item in the original layout.

16. The electronic device of claim 15, wherein the computer code for positioning of the primary element relative to the position of the background element includes:
computer code for identifying the distance between a center point of the primary element and an origin of the background item;
computer code for measuring a length of the background item;
computer code for measuring a width of the background item;
computer code for calculating a first ratio of the identified distance to the length of the background item; and
computer code for calculating a second ratio of the identified distance to the height of the background item.

17. The electronic device of claim 14, wherein the content comprises an Internet web page.

18. A module, comprising:
a processor for processing information; and
a memory unit operatively connected to the processor, the memory unit including a computer program product for handling absolute positioning of content in an optimized layout on a display, comprising:
computer code for providing content in an original layout, the content including a primary element;
computer code for identifying a background element within the content;
computer code for calculating a model of the content, the calculation including determining the position of the primary element relative to the position of the background element;
computer code for scaling the background element for use in the optimized layout; and
computer code for positioning the primary element in the optimized layout in the same position relative to the background element as in the original layout.

19. The module of claim 18, wherein the background element comprises at least a portion of a background item, and wherein the primary element overlaps with at least a portion of the background item in the original layout.

20. The module of claim 19, wherein the computer code for positioning of the primary element relative to the position of the background element includes:
computer code for identifying the distance between a center point of the primary element and an origin of the background item;
computer code for measuring a length of the background item;
computer code for measuring a width of the background item;
computer code for calculating a first ratio of the identified distance to the length of the background item; and
computer code for calculating a second ratio of the identified distance to the height of the background.

21. A server, comprising:
a processor for processing information; and
a memory unit operatively connected to the processor, the memory unit including a computer program product for handling absolute positioning of content in an optimized layout on a display of an electronic device, comprising:
computer code for providing content in an original layout, the content including a primary element;
computer code for identifying a background element within the content;
computer code for calculating a model of the content, the calculation including determining the position of the primary element relative to the position of the background element;
computer code for scaling the background element for use in the optimized layout; and
computer code for positioning the primary element in the optimized layout in the same position relative to the background element as in the original layout.
